(19) United States
(12) Patent Application Publication
(10) Pub. No.: US 2026/0199805 A1
(43) Pub. Date: Jul. 16, 2026

(54) ASSEMBLY AND METHOD FOR REGENERATING CONTAMINATED HEAT TRANSFER FLUIDS

(71) Applicant: EASTMAN CHEMICAL COMPANY, KINGSPORT, TN (US)

(72) Inventor: ROBERT LIN, KINGSPORT, TN (US)

(73) Assignee: EASTMAN CHEMICAL COMPANY, KINGSPORT, TN (US)

(21) Appl. No.: 19/136,342

(22) PCT Filed: Dec. 5, 2023
(86) PCT No.: PCT/US2023/082450

§ 371 Date: Jun. 6, 2025

Related U.S. Application Data
(60) Provisional application No. 63/386,354, filed on Dec. 7, 2022.

(51) Int. Cl. B01D 3/14; C10G 7/00

(52) U.S. Cl. CPC B01D 3/141; C10G 7/00; C10G 2400/30

(57) ABSTRACT

A synthetic aromatic heat transfer fluid regenerating assembly is disclosed. The synthetic aromatic heat transfer fluid regenerating assembly heat transfer fluid regenerating assembly of the present invention includes (a) a fluid connector for fluidly connecting the synthetic aromatic heat transfer fluid regenerating assembly to a heat transfer system that includes contaminated synthetic aromatic heat transfer fluid contained in a heat transfer loop; and (b) a divided wall distillation column fluidly connected to the fluid connector and including a side-draw outlet. A related heat transfer assembly and a method for regenerating contaminated synthetic aromatic heat transfer fluid from a heat transfer system are also described.

### FIELD OF THE INVENTION

The present invention is generally directed to methods for purification and regeneration of synthetic aromatic heat transfer fluids, in particular synthetic aromatic heat transfer fluids including a eutectic mixture of diphenyl oxide and biphenyl compounds, as well as systems and assemblies useful in performing such methods.

### BACKGROUND OF THE INVENTION

Materials known as a heat transfer fluids, also sometimes referred to in the art as heat transfer oils or thermal fluids, are well known in the art. As the name suggests, heat transfer fluids have the capacity to hold and transfer/absorb thermal energy and are therefore useful for example as a media in a closed recirculating cycle between a central heat source, on the one hand, and one or more heat sinks or process users on the other. The heat sink may be, for example, the reboiler of a distillation column, a jacketed autoclave, a steam generator and similar apparatuses.

Heat transfer fluids suitable as heating media may generally exhibit low vapor pressures, a nearly constant boiling point, excellent heat transfer characteristics and good thermal stability. One class of heat transfer fluids that have achieved high commercial success over the years may be generically described as synthetic aromatic heat materials, and the class may include biphenyls (diphenyl, phenylbenzene), terphenyls, and partially hydrogenated terphenyls (PHT's). These materials may be single compounds and/or mixtures thereof. Additionally, these materials may synthetic aromatic heat materials blended with other compounds, for example, but not limited to hydrocarbons, hydrocarbon derivatives, or polymeric materials such as polysiloxanes. Eutectic mixtures of biphenyl and diphenyl oxides maybe referred to herein and, in the art, as “DPO” heat transfer fluids. Commonly used components of other commercially available synthetic aromatic heat transfer fluids may include the partially hydrogenated terphenyls (PHTs) or partially hydrogenated quaterphenyls.

Despite the exceptional thermal stability of heat transfer fluids, they remain prone to thermal degradation over extended periods of use at elevated temperatures or under non-recommended usage conditions. Such degradation typically involves decomposition in which the molecular bonds of the original fluid molecular structure break to form generally two large categories of degradation products: light compounds (low boilers), which may include benzene and phenol in the instance of DPO fluids; and heavy compounds (high boilers), which may include o-terphenyl, m-terphenyl, p-terphenyl and 2-phenoxybiphenyl, as well as, tars and polymers in the instance of DPO fluids. The concentration of these degradation contaminants in the synthetic aromatic heat transfer fluid should not exceed certain manufacturer limits due in part to the fact that light components, having a high vapor pressure, may increase the pressure in the system and can cause cavitation in the pumps, while the heavy components limit the efficiency of the heat transfer as, among other things, they may reduce or increase the specific heat of the heat transfer oil and increase its viscosity to form high boiling thermal decomposition products and low boiling thermal decomposition products as contaminants. If allowed to accumulate in the system, the degradation contaminants would eventually render the entire fluid inventory unfit for continuing use. Environmental concerns and related governmental regulation may also drive contaminant concentration limits.

The art has recognized the importance of removing these degradation contaminants from heat transfer fluid inventories and proposed solutions for their removal. An early attempt is described in U.S. Pat. No. 4,139,418, directed to a method and apparatus for the distillation purification of organic heat transfer fluids utilizing an electrically heated still or purifier for the distillation purification of heat transfer fluids such as diphenyl, diphenyl ether and mixtures thereof which are contaminated with high boiling thermal decomposition products. In a more recent effort, U.S. Pat. No. 9,211,484 describes a plan and a process for regenerating degraded heat transfer oil. Even more recently, U.S. Pat. No. 10,058,969 issued, describing a system and method removing thermal decomposition components from biphenyl and/or diphenyl oxide heat-transfer fluids.

These prior art technical solutions have demonstrated various drawbacks and therefore achieved limited commercial success. First, implementing the described solutions as a component of a larger heat transfer system dramatically increases the cost of capital required to construct such systems. Further, such solutions typically require shutdown or pause of the manufacturing process/facility associated with the heat transfer system, adding inefficiencies and downtime costs to the production facility. De-contamination systems located and operated off-site from the heat transfer system require shutdown, cooldown, and draining of the heat transfer system, collection and transportation of the fluid, adding downtime cost and potential concern regarding fluid transport. Independently contract-operated off-site systems may process multiple fluid types for multiple different customers, introducing the possibility of fluid cross-contamination. Systems that are used periodically, e.g., when the fluid becomes sufficiently contaminated so as to require clean-up, create system inefficiencies while sitting idle.

An unmet need therefore exists for a lower-cost, lower-investment method and device for regenerating contaminated heat transfer fluids that allows for continuing operation of the related heat transfer system and chemical facility while concurrently regenerating the heat transfer fluid by effectively removing contaminant degradation products.

### SUMMARY OF THE INVENTION

In an embodiment herein, disclosed are methods for regenerating contaminated synthetic aromatic heat transfer fluid from a heat transfer system comprising contaminated synthetic aromatic heat transfer fluid contained in a heat transfer loop. The methods comprise the steps of (a) diverting at least a portion of said contaminated synthetic aromatic heat transfer fluid from said heat transfer system to form a feed stream comprising diverted contaminated synthetic aromatic heat transfer fluid; and (b) passing said feed stream comprising diverted contaminated synthetic aromatic heat transfer fluid into a synthetic aromatic heat transfer fluid regenerating assembly, said synthetic aromatic heat transfer fluid regenerating assembly comprising a divided wall distillation column, to form a side draw stream, a low boiler distillate stream and high boiler distillate stream.

In another embodiment herein, disclosed are synthetic aromatic heat transfer fluid regenerating assemblies. The synthetic aromatic heat transfer fluid regenerating assemblies comprise (a) a fluid connector for fluidly connecting said synthetic aromatic heat transfer fluid regenerating assembly to a heat transfer system, said system comprising contaminated synthetic aromatic heat transfer fluid contained in a heat transfer loop; and (b) a divided wall distillation column fluidly connected to said fluid connector and including a side-draw outlet.

In a further embodiment herein, disclosed are heat transfer assemblies. The heat transfer assemblies comprise a heat transfer system comprising contaminated synthetic aromatic heat transfer fluid contained in a heat transfer loop and a synthetic aromatic heat transfer fluid regenerating assembly fluidly connected to said heat transfer system, wherein said heat transfer fluid regenerating assembly comprises a divided wall distillation column.

In one or more method embodiments herein, said heat transfer system is an operating heat transfer system comprising circulating contaminated synthetic aromatic heat transfer fluid that is circulating in said heat transfer loop and said collecting step (a) comprises diverting at least a portion of said circulating contaminated synthetic aromatic heat transfer fluid from said heat transfer system (or said heat transfer loop) to form a diverted contaminated synthetic aromatic heat transfer fluid stream.

In one or more method embodiments herein, said synthetic aromatic heat transfer fluid regenerating assembly is a releasably connectable synthetic aromatic heat transfer fluid regenerating assembly and said method further comprises, prior to step (b), a step of connecting said releasably connectable synthetic aromatic heat transfer fluid regenerating assembly to said heat transfer system.

In one or more method embodiments herein, the methods may further comprise a step of disconnecting said releasably connectable synthetic aromatic heat transfer fluid regenerating assembly from said heat transfer system.

In one or more method embodiments herein, the methods may further comprise accumulating at least one of said low boiler distillate stream and said high boiler distillate stream in at least one sequestering reservoir. In one or more method embodiments herein, the methods further comprise accumulating said low boiler distillate stream in a low boiler sequestering reservoir and/or accumulating said high boiler distillate stream in a high boiler sequestering reservoir.

In one or more method embodiments herein, the methods may further comprise returning at least a portion of material from said side draw stream to said heat transfer system.

In one or more assembly embodiments herein, the assemblies may further comprise at least one light boiler sequestering reservoir fluidly connected to said divided wall distillation column; and at least one heavy boiler sequestering reservoir fluidly connected to said divided wall distillation column.

In one or more assembly embodiments herein, the assemblies may further comprise said heat transfer fluid regenerating assembly comprising a releasable fluid connector releasably connecting said heat transfer fluid regenerating assembly to said heat transfer loop. In one or more assembly embodiments herein, the fluid connector is a releasable fluid connector.

In one or more assembly embodiments herein, the heat transfer assembly may be an operating heat transfer assembly comprising includes a first portion of contaminated synthetic aromatic heat transfer fluid circulating in said heat transfer loop and a second portion of contaminated synthetic aromatic heat transfer fluid flowing into said synthetic aromatic heat transfer fluid regenerating assembly.

In one or more assembly embodiments herein, the assembly is purposefully transportable.

In one or more assembly embodiments herein, said at least one light boiler sequestering reservoir comprises a sequestering condenser and/or said at least one heavy boiler sequestering reservoir comprises a sequestering reboiler.

In one or more assembly embodiments herein, divided wall distillation column, said at least one light boiler sequestering reservoir and said at least one heavy boiler sequestering reservoir together form a single modular unit. In one or more assembly embodiments herein, the modular units is purposefully transportable.

In one or more assembly embodiments herein, the assemblies may further comprise a regenerated synthetic aromatic return line releasably connected to said heat transfer loop.

Further aspects of the invention are as disclosed and claimed herein.

### BRIEF DESCRIPTION OF THE DRAWINGS

FIG. 1 is a schematic flow chart of an embodiment of the synthetic aromatic heat transfer assembly and method of the present invention;

FIG. 2 is a schematic diagram of another embodiment of the synthetic aromatic heat transfer fluid regenerating assembly of the present invention;

FIG. 3 is a schematic diagram of an embodiment of the synthetic aromatic heat transfer fluid regenerating assembly of the present invention including a sequestering low boiler reservoir with multiple reboilers;

FIG. 4 is a schematic diagram of an embodiment of the synthetic aromatic heat transfer fluid regenerating assembly of the present invention including a sequestering low boiler reservoir with multiple reboilers and a transfer line;

FIG. 5 is a schematic diagram of an embodiment of the synthetic aromatic heat transfer fluid regenerating assembly of the present invention including a sequestering high boiler reservoir with multiple condensers and reflux vessels;

FIG. 6 is a schematic diagram of an embodiment of the synthetic aromatic heat transfer fluid regenerating assembly of the present invention utilized in Example 1 of the present application; and

FIG. 7 is a schematic diagram of a Comparative Example set forth in the present application.

### DETAILED DESCRIPTION

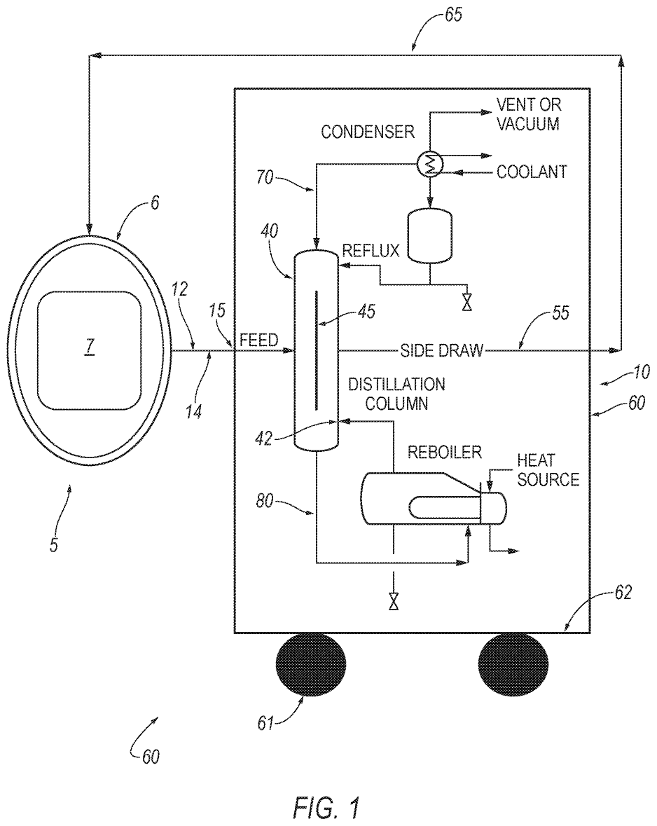

With general reference to FIGS. 1 through 7, the present invention in a first aspect relates to method for regenerating contaminated synthetic aromatic heat transfer fluid from a heat transfer system 5 that includes a heat transfer loop 6. The method of the present invention includes the steps of (a) diverting at least a portion of said contaminated synthetic aromatic heat transfer fluid from said heat transfer system 5 to form a diverted contaminated synthetic aromatic heat transfer fluid stream or feed stream 12; and (b) passing said diverted contaminated synthetic aromatic heat transfer fluid stream 12 into a divided wall distillation column 40 to process said diverted contaminated synthetic aromatic heat transfer fluid stream 12 into a side draw stream 55 with sequestration of low boilers in a low boiler sequestration reservoir such as a reflux drum and sequestration of high boilers in a high boiler sequestration reservoir 85 such as a reboiler. Removal of low boilers and high boilers from the system can be accomplished on continuous, batch or semi-batch basis.

The phrase “heat transfer system” as utilized herein is meant to broadly include systems, devices and apparatuses that include a heat transfer fluid contained or circulating in a heat transfer loop and that functions to transport heat energy to or away from a chemical or similar system, device or operation. In one non-limiting example, a heat transfer system may transfer heat energy between a central heat source, on the one hand, and one or more heat sinks or process users on the other. The heat sink may be, for example, the reboiler of a distillation column, a jacketed autoclave, a steam generator or the like. The heat transfer fluid may be present for example in the vapor and/or the liquid state.

In one or more embodiments, the heat transfer fluid includes a synthetic aromatic heat transfer fluid. Synthetic aromatic heat transfer fluids are common in the art and include materials such as biphenyls (diphenyl, phenylbenzene), terphenyls, and partially hydrogenated terphenyls (PHT's) that may degrade and form degradation products. Other heat transfer fluids include eutectic mixtures of biphenyl and diphenyl oxide, such as Therminol VP-1™ available from Eastman Chemical Company and Dowtherm A™ available from Dow Inc.

“Contaminated synthetic aromatic heat transfer fluid,” as the phrase is utilized herein, is meant to include without limitation heat transfer fluids that contain contaminants such as synthetic aromatic degradation products generated in the course of use of the synthetic aromatic heat transfer fluids either typical or atypical usage. Generation, chemical make-up and type of degradation products are generally specific to the initial composition of the heat transfer fluid(s) and/or the manner in which the fluid is utilized. Although seemingly paradoxical, some degradation products may be detrimental to one specific type of heat transfer fluid while being acceptable to another heat transfer fluid. In an example illustrated by the example and comparative example described below, heat transfer fluids such as Dowtherm A® or Therminol® VP-1 are comprised mostly of biphenyl and biphenyl oxide that may generate degradation products including but not limited to benzene and phenol as low boilers, and isomers of terphenyls as high boilers.

“Regenerated synthetic aromatic heat transfer fluid,” as the phrase is utilized herein, is meant to include without limitation heat transfer fluids from which at least some amount of one or more contaminant degradation products from a contaminated synthetic aromatic heat transfer fluid feed or sample have been removed. In one or more embodiments, the method of the present invention generates a side-draw stream comprising regenerated synthetic aromatic heat transfer fluid with a total contaminant degradation product level of from approximately 0.5 to 40 percent by weight.

In the method of the present invention, a portion of said contaminated synthetic aromatic heat transfer fluid from a heat transfer system is diverted from a heat transfer system to form a diverted contaminated synthetic aromatic heat transfer fluid stream. A particularly utilitarian feature of the present invention is that, in one or more embodiments, the method may facilitate regeneration of contaminated synthetic aromatic heat transfer fluid while the subject heat transfer system is operational or performing its heat transfer function. Stated another way, heat transfer fluid may continue to circulate in a heat transfer system loop of a heat transfer system concurrently with the regeneration method of the present invention such that the heat transfer system is operating while the contaminated synthetic aromatic heat transfer is processed through the apparatus. This may be achieved by diverting some portion of the contaminated synthetic aromatic heat transfer fluid contained and/or circulating in the heat transfer system, forming a diverted contaminated synthetic aromatic heat transfer fluid stream. In the diverting step, at least 0.01% or at least 0.1% or at least 1% of the contaminated synthetic aromatic heat transfer fluid from the heat transfer system is diverted to form the diverted contaminated synthetic aromatic heat transfer fluid stream.

One or ordinary skill will appreciate that, in embodiments wherein regeneration is not necessarily concurrent with the heat transfer operation (i.e., the heat transfer system is shut down or off-line), up to 100% of the contaminated synthetic aromatic heat transfer fluid contained in the heat transfer system may be diverted in the diverting step.

In the method of the present invention, the diverted contaminated synthetic aromatic heat transfer fluid stream formed in the diverting step (a), also referred to herein and depicted in the Figures as feed stream 12, is passed into a synthetic aromatic heat transfer fluid regenerating assembly 10 comprising a divided wall distillation column 40. In the divided wall distillation column, the diverted contaminated synthetic aromatic heat transfer fluid stream is processed into a side draw stream 55 with sequestration of low boilers in a low boiler sequestration reservoir 75 which in some embodiments may comprise a reflux drum and sequestration of high boilers in a high boiler sequestration reservoir 85 which in some embodiments may comprise a reboiler. Removal of low boilers and high boilers from the system can accomplished on continuous, batch or semi-batch basis.

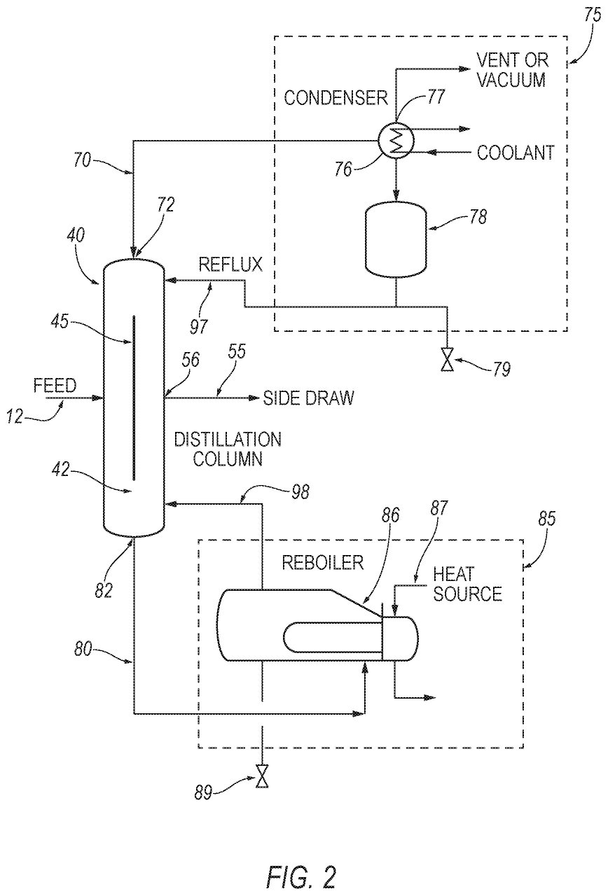

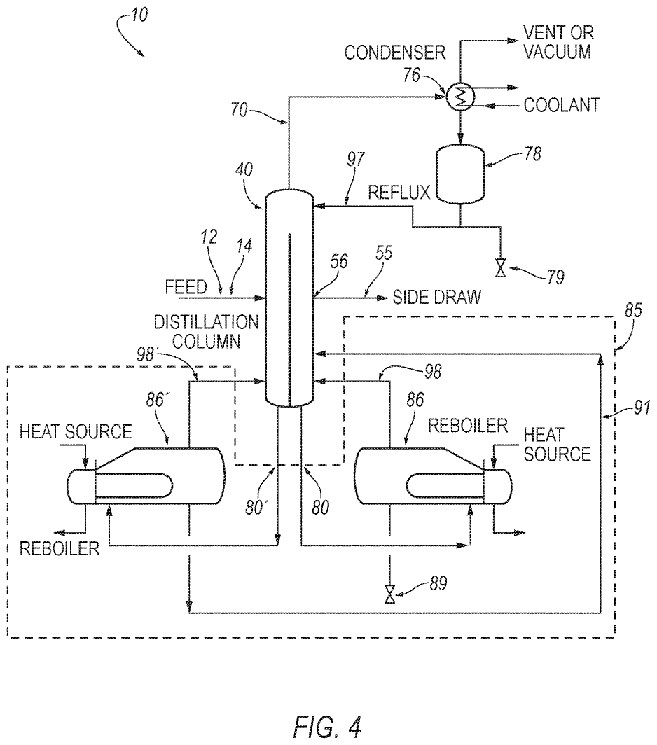

Divided wall distillation columns, also referred to as divided wall columns (DWCs) or dividing wall distillation columns, are known in art and generally include a column 40 with a wall or similar structure, shown in the Figures at 45, partitioning the column interior 42. Divided wall distillation columns are described for example in U.S. Pat. No. 6,958,111, the contents and disclosure of which are hereby incorporated herein by reference. Various partition wall configurations for divided wall columns are suitable for the present invention, including without limitation a wall 45 extending centrally in the column as shown in FIGS. 1 and 2; a wall extending 45 from the top of the column toward the center as shown in FIG. 4; a wall 45 extending from the bottom or base of the column toward the center as shown in FIGS. 2, 3 and 5; and annular walls extending circumferentially around the column interior and separating a central distillation zone from an annular distillation zone.

In the divided wall distillation column 40, the diverted contaminated synthetic aromatic heat transfer fluid stream, labeled as a feed stream 12 in the FIGS., is processed into outlet streams which include a side draw stream 55 exiting column 40 with sequestration of low boilers in a reflux drum XXX, and sequestration of high boilers in a reboiler. Removal of low boilers and high boilers from the system can accomplish on continuous, batch or semi-batch basis. As a general proposition, the low boiler distillate stream may include components corresponding to contaminant degradation products with a boiling point lower than the nominal boiling point of the uncontaminated heat transfer fluid and may ultimately be removed generally from the upper portion of the DWC; the high boiler distillate stream may include components corresponding to contaminant degradation products with a nominal boiling point higher than the boiling point of the uncontaminated heat transfer fluid and may ultimately be removed from the lower portion of the DWC; and the side-draw stream may include regenerated heat transfer fluid as a primary component and may be collected and/or be returned as reclaimed heat transfer fluid via an outlet from the central portion of the DWC. Though approximate locations for these outlets 56, 72 and 82 are exemplified in the Figures, it should be understood that their precise locations along the column 40 may vary depending on a number of factors including for example type and amount of contaminant degradation product(s), specific composition and components for the heat transfer fluid.

A differentiating feature of the method of the present invention is the accumulation and sequestering of distillate streams 70 and 80 during processing of contaminated synthetic aromatic heat transfer fluid. Accordingly, in one or embodiments, the method of the present invention further includes collecting or accumulating at least one of said low boiler distillate stream and said high boiler distillate stream in sequestering reservoirs. In one or more embodiments, the method of the present invention further includes collecting or accumulating said low boiler distillate stream 70 in a low boiler sequestering reservoir 75 and collecting or accumulating said high boiler distillate stream 80 in a high boiler sequestering reservoir 85. Example configurations, not intended to be limiting, are provided in FIGS. 2 through 6.

Reservoirs 75 and 85 for collecting and sequestering the distillate streams may include one or more vessels, with or without additional components, such as are known in the art as suitable for chemical processing applications. In one non-limiting example, a sequestering reservoir 85 for the high boiling distillate stream 80 may include one or more sequestering reboilers or reflux boilers 86 that includes heating contacts 87. In one non-limiting example, the low boiler sequestering reservoir 75 for the low boiling distillate stream 70 may include one or more sequestering condensers 76 that may include coolant contacts 77 and one or more collection vessels (e.g., reflux drums) 78. It would be appreciated by one or ordinary skill in that, depending on for example size, construction and system requirements, reboilers and condensers may also function as storage/collection vessels or may require separate storage vessels in-line therewith. A portion of the content of the reservoirs 75 and 85, referred to from time to time as reflux or boilup, may be returned to the divided wall column as shown generally at 97 and 98, correspondingly. Accordingly, in one or more embodiments, Sequestering reservoirs may more generally include devices known in the art as capable and/or useful for collection, accumulation or storage of fluids, more particularly contaminants and/or synthetic aromatic heat transfer fluid, with non-limiting examples including pressure vessels, bladders, receptables, tanks, pipelines and like.

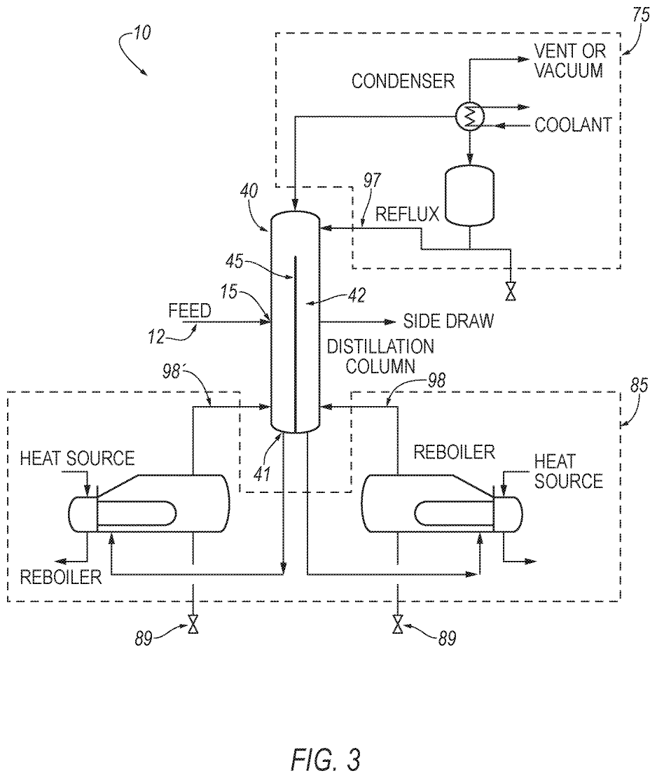

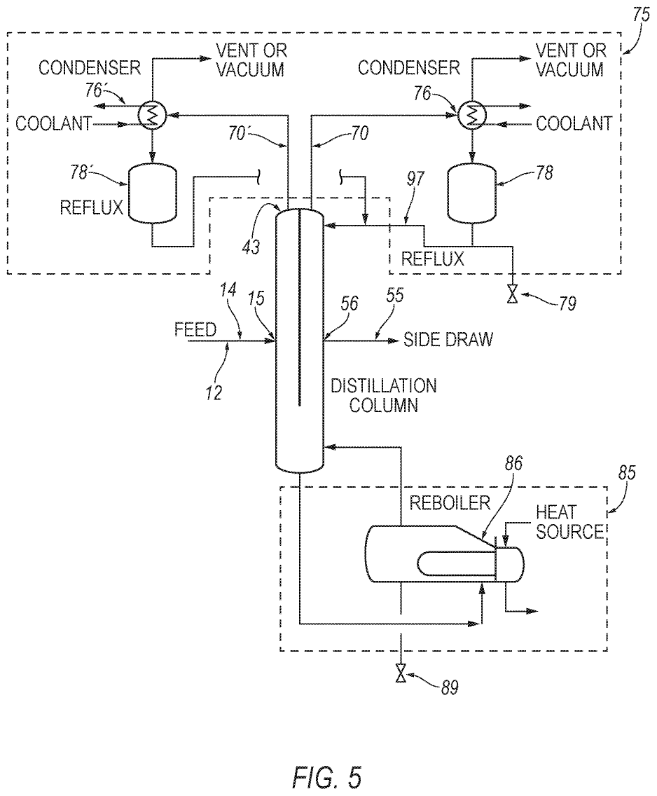

Methods and assemblies of the present invention that utilize more than one sequestering condenser, more than one sequestering reboiler and multiple related collection vessels are contemplated. In non-limiting examples, FIGS. 3 and 4 depict non-limiting embodiments that include multiple high boiler distillate streams 80 and 80′, sequestering reboilers 86 and 86′ and reflux streams 98 and 98′ (with FIG. 4 further depicting a transfer stream 91 that facilitates transfer of fluid from one side of the DWC to the other side); FIG. 5 depicts multiple low boiler distillate streams 70 and 70′, condensers 76 and 76′, collection vessels 78 and 78′.

In one or more embodiments of the method of the present invention, the method may include continuously or periodically draining contaminants from sequestering reservoirs. In one or more embodiments of the method of the present invention, the method may include continuously or periodically returning at least a portion of contaminants from sequestering reservoirs to the DWC as one or more distillate streams.

Accordingly, in one or more embodiments, the method of the present invention may include accumulating low boiling contaminants (as distillate) in one or more low boiler sequestering reservoirs and returning at least a portion of the low-boiling contaminants back to the DWC as a reflux stream 97, preferably in the absence of any low boiler draining or removal. Similarly, in one or more embodiments, the method of the present invention may include accumulating high boiling contaminants (as distillate) in one or more high boiler sequestering reservoirs and returning at least a portion of the contaminants back to the DWC as a boilup stream 98, preferably in the absence of any high boiling contaminant draining or removal.

In one or more embodiments, the method of the present invention includes pre-charging the divided wall distillation column with a charge of synthetic aromatic heat transfer fluid or contaminated synthetic aromatic heat transfer fluid prior to passing step (b). In one or more embodiments, the mass flowrate of the feed stream 12 and the side-draw stream 55 are nominally equivalent.

Although the removal of impurities or contaminants, and therefore the method of the present invention, may in some embodiments may be continuous, batch, or semi-batch, there some distinct advantages to batch or periodic removal of impurities such that the method of the present invention may also be batch or periodic. For example, by eliminating continuous removal of low boiler and/or continuous removal of high boilers, it is possible to simplify the operation of the DWC by eliminating control valves and other instrumentation associated with the process control of continuous material streams. Another potential advantage with batch or semi-batch removal of impurities is related to the in-situ sequestration of impurities. In one non-limiting operating configuration, it may be possible to eliminate additional storage (tankage) of impurities by draining the built-up impurities directly into waste containers for disposal. In principle, the reduction in the number of physical transfers of material can reduce the risk of unintentional spills or release of pollutants.

Another important feature of one or more embodiments of the present invention is the modular construction and releasable connectability of the synthetic aromatic heat transfer fluid regenerating assembly, an aspect of the present invention described in more detail below. In such embodiments, the heat transfer fluid regenerating assembly of the present invention may be purposefully transportable or mobile as a “module” that may be connected to a heat transfer loop for reclamation of contaminated heat transfer fluid and then disconnected and re-used at a separate location or site for reclamation of another contaminated heat transfer fluid, even one of a different chemical class. Such re-usability may facilitate the leasing or renting of such a module to a heat transfer fluid customer/user or the purchase of such a module by a heat transfer user/customer with facilities at multiple locations. Accordingly, in one or more embodiments of the method of the present invention, the method may include, prior to passing step (b), a step of connecting a releasably connectable synthetic aromatic heat transfer fluid regenerating assembly to said heat transfer system. In one or more embodiments of the method of the present invention, the method may include a step of disconnecting the releasably connectable synthetic aromatic heat transfer fluid regenerating assembly from said heat transfer system.

Another important feature of one or more embodiments of the present invention is the mobility or transportability of the synthetic aromatic heat transfer fluid regenerating assembly, an aspect of the present invention described in more detail below. Accordingly, in one or more embodiments of the method of the present invention, the method may include, prior to a step of connecting a releasably connectable synthetic aromatic heat transfer fluid regenerating assembly to said heat transfer system, a step of transporting the releasably connectable synthetic aromatic heat transfer fluid regenerating assembly to a site that includes a heat transfer system or heat transfer loop. Similarly, in one or more embodiments of the method of the present invention, the method may include, subsequent to a step of disconnecting the releasably connectable synthetic aromatic heat transfer fluid regenerating assembly from said heat transfer system, a step of transporting the releasably connectable synthetic aromatic heat transfer fluid regenerating assembly away from a site that includes a heat transfer system or heat transfer loop.

In a second and related aspect, the present invention relates to a synthetic aromatic heat transfer fluid regenerating assembly. The synthetic aromatic heat transfer fluid regenerating assembly of the present invention, generally referenced in the Figures at 10, includes (a) a fluid connector 15 for fluidly connecting said synthetic aromatic heat transfer fluid regenerating assembly to a heat transfer system 5, said system comprising contaminated synthetic aromatic heat transfer fluid contained and/or circulating in a heat transfer loop 6; (b) a divided wall distillation column 40 fluidly connected to said fluid connector and including a side-draw outlet 56; (c) a low boiler sequestering reservoir 75 fluidly connected to said divided wall distillation column 40; and e) at least one high boiler sequestering reservoir 85 fluidly connected to said divided wall distillation column 40.

One of ordinary skill will understand and appreciate that elements or features described in one aspect or embodiment of the present invention may be applicable and useful in describing other aspects or embodiments. By way of non-limiting examples, the description of the divided wall distillation column set forth in the context of the method of the present invention is also applicable and useful in describing the divided wall distillation column feature of the heat transfer system of the present invention and/or the synthetic aromatic heat transfer fluid regenerating assembly of the present invention. Further, descriptions related to the divided wall distillation column set forth in the context of the heat transfer system of the present invention and the synthetic aromatic heat transfer fluid regenerating assembly of the present invention are also applicable and useful in describing the divided wall distillation column in the context of the method of the present invention. Similarly, description relating to the at least one low boiler sequestering reservoir set forth in the heat transfer system aspect of the present invention and/or the synthetic aromatic heat transfer fluid regenerating assembly aspect of the present invention may be applicable and useful in describing the low boiler sequestering reservoir feature of the methods of the present invention. Accordingly, descriptions and disclosure relating to elements or features of an aspect or embodiment of the present invention are hereby expressly relied on to describe and support those elements or features in other aspects or embodiments.

The synthetic aromatic heat transfer fluid regenerating assembly of the present invention 10 includes a fluid connector 15 for fluidly connecting the synthetic aromatic heat transfer fluid regenerating assembly to a heat transfer system 5. Typical heat transfer systems to which the synthetic aromatic heat transfer fluid regenerating assembly 10 may be fluidly connected include a heat transfer fluid, for example synthetic aromatic heat transfer fluid or contaminated synthetic aromatic heat transfer fluid, which is contained in a heat transfer loop 6 and which, when the heat transfer system is in operation, circulates in the heat transfer loop 6 to transfer heat energy between the heat transfer fluid and a chemical system or device 7. Such heat transfer systems are utilized in a wide variety of industries and systems where heat transfer is required. Heat transfer systems and heat transfer loops using synthetic heat transfer fluids may found for example in the chemical industry as a heating utility in conjunction or as an alternative to steam systems; in concentrated solar power (CSP) systems for storing and distributing thermal energy; and in nuclear power systems for storing thermal energy and as a reactor coolant. Heat transfer systems and heat transfer loops in various utilities are also described for example in U.S. Pat. Nos. 3,756,312 and 4,744,408 and U.S. Published Patent Application No. 2013/0086904, the contents and disclosure of which are hereby incorporated herein by reference.

The fluid connector 15 may be any fluid connector with a structure or construction and suitable elements to allow fluid communication between the heat transfer system 5 or its heat transfer loop 6 and the synthetic aromatic heat transfer fluid regenerating assembly 10 such that heat transfer fluid contained in the heat transfer loop, or at least a portion thereof, may flow or be diverted from the heat transfer system 5 to the synthetic aromatic heat transfer fluid regenerating assembly 10. Non-limiting examples of such fluid connectors are well known in the art and include valves, T-joints, etc. and the like as well as combinations thereof. In certain embodiments, the fluid connector may be located adjacent the column 40, the heat transfer loop 6 of at a location between the two. In embodiments wherein the assembly includes an enclosure 60 as shown in FIG. 1, the connector may be located adjacent such enclosure or at a location between the enclosure and the heat transfer loop 6.

In one or more embodiments, the fluid connector is a releasable fluid connector. The term “releasable” in intended to include connectors that are purposefully designed or constructed to non-permanently establish fluid communication between the synthetic aromatic heat transfer fluid regenerating assembly 10 and a heat transfer system 5 with the capacity to readily detach, separate or other disconnect the synthetic aromatic heat transfer fluid regenerating assembly from the heat transfer system. Releasable fluid connectors are well known in the art and include flexible hose connections, flanged piping connections, tubing connectors (e.g. Swagelok™ brand connectors and the like. Releasable fluid connectors may further include “two-piece” connectors that may include a first component that is part of the synthetic aromatic heat transfer fluid regenerating assembly and a second component that is a part of the heat transfer system of the heat transfer loop and that mates with or couples to the first component. Releasable fluid connectors may also include valves and/or other equipment components for measuring or controlling aspects of material movement and transfer.

While the fluid connector preferably fluidly connects the regenerating assembly directly to the heat transfer system per se, embodiments wherein the fluid connector for fluidly connecting said synthetic aromatic heat transfer fluid regenerating assembly to one or more intermediate heat transfer fluid storage vessels are also contemplated and within the scope of the present invention.

Important and related (but independent) features of one or more embodiments of the present invention are (i) modular construction and (ii) releasable connectability of the synthetic aromatic heat transfer fluid regenerating assembly to a heat transfer system. In such embodiments, the synthetic aromatic heat transfer fluid regenerating assembly may be a module or modular unit or a single unit or a single self-contained unit or a single enclosed unit as depicted in FIG. 1. In one or more embodiments, the synthetic aromatic heat transfer fluid regenerating assembly may be purposefully transportable and include elements such an enclosure 60 with a support base such as a skid or similar structure. In such embodiments, the assembly is constructed and assembled to facilitate movement or transportation, e.g., between various physical heat transfer system sites or from an inactive, remote or storage location to an active functional location near or adjacent to a heat transfer system and with optional return to the inactive, remote or storage location. In some embodiments, the assembly may include one or more wheels or rollers 61 mounted thereon to facilitate movement and transport. In some embodiments, the assembly may include mounting equipment such as lugs or brackets for temporary or permanent fastening to a structure or the floor or ground. In some embodiments, the assembly may include power connectors for removable connection with a power source. Similarly, the assembly may include connectors for other functions such as connectors for monitoring instrumentation, utility connectors (steam, cooling water, inert gas, compressed air, etc.) and safety systems. In such embodiments, the synthetic aromatic heat transfer fluid regenerating assembly may be a releasably connectable synthetic aromatic heat transfer fluid regenerating assembly and may include a releasable fluid connector for fluidly connecting said synthetic aromatic heat transfer fluid regenerating assembly to a heat transfer system.

The synthetic aromatic heat transfer fluid regenerating assembly of the present invention includes a divided wall distillation column 40 fluidly connected to said fluid connector. Divided wall distillation columns, also referred to as divided wall columns (DWCs) or dividing wall distillation columns, are known in art and generally include a column with a wall or similar structure partitioning the column interior. Various partition wall configurations for divided wall columns are suitable for the present invention, including without limitation configurations previously described herein and depicted in the Figures. The divided wall distillation column 40 may include a side-draw outlet 56.

The material obtained from the side-draw outlet 56, also referred to as side stream 55, includes regenerated synthetic aromatic heat transfer fluid. Regenerated synthetic aromatic heat transfer fluid includes a level of at least one degradation product contaminant that is lower than the level of that contaminant present in the contaminated synthetic aromatic heat transfer fluid. In one or more embodiments, the regenerated heat transfer fluid may be collected. In one or more embodiments, the regenerated heat transfer fluid may be returned to the heat transfer system 5.

The synthetic aromatic heat transfer fluid regenerating assembly 10 of the present invention may include at least one low boiler sequestering reservoir 75 fluidly connected to said divided wall distillation column 40. A function of the low boiler sequestering reservoir 75 is to collect and accumulate material emanating from a divided wall distillation column low boilers outlet, such material often described as “low boilers” or “lights” in the sense that the material exhibits a boiling point lower than that of the synthetic aromatic heat transfer fluid. Such material may be generated by degradation of the synthetic aromatic heat transfer fluid due to usage over time, resulting in contamination of the synthetic aromatic heat transfer fluid, and corresponding reduction and/or elimination of heat transfer functionality.

In one or more embodiments, the synthetic aromatic heat transfer fluid regenerating assembly may include low boilers reflux pipeline 97 for returning a portion of the accumulated contaminants as reflux. In this reflux, at least some portion of the low boilers from the low boiler sequestering reservoir 75 may be recycled or returned to the divided wall distillation column 40 for further processing, for example, further enrichment of low boiler concentration. Low boilers may be sequestered and accumulated in sequestering reservoir 75 over time and periodically collected via one or more collection ports 79.

In one or more embodiments, at least one low boiler sequestering reservoir 75 may include a include a sequestering condenser 76 wherein low boilers may be condensed in conjunction with the accumulation and sequestration process and, in some embodiments, collected in a reflux drum or similar collection vessel 78.

The synthetic aromatic heat transfer fluid regenerating assembly 10 of the present invention may include at least one high boiler sequestering reservoir 85 fluidly connected to said divided wall distillation column. One purpose of the high low boiler sequestering reservoir is to collect and accumulate high boiling material emanating from a divided wall distillation column, such material often described as “high boilers” or “heavies” in the sense that the material exhibits a boiling point higher than that of the heat transfer fluid. Such material may be generated by degradation of the heat transfer fluid due to usage over time, and resulting in contamination of the heat transfer fluid and corresponding reduction and/or elimination of heat transfer functionality.

In one or more embodiments, the synthetic aromatic heat transfer fluid regenerating assembly may include boilup pipeline 98 for returning at least some of the accumulated high boiling contaminants to the DWC. In this boilup, at least some portion of the high boilers from the high boiler sequestering reservoir 85 may be recycled or returned to the divided wall distillation column 40 for further processing, for example, further enrichment of high boiler concentration. High boilers may be sequestered and accumulated in sequestering reservoir 85 over time and periodically collected via one or more collection ports 89.

In one or more embodiments, at least one high boiler sequestering reservoir 85 may include at least one sequestering reboiler 86 wherein at least some of the high boilers may be vaporized in conjunction with the accumulation and sequestration process.

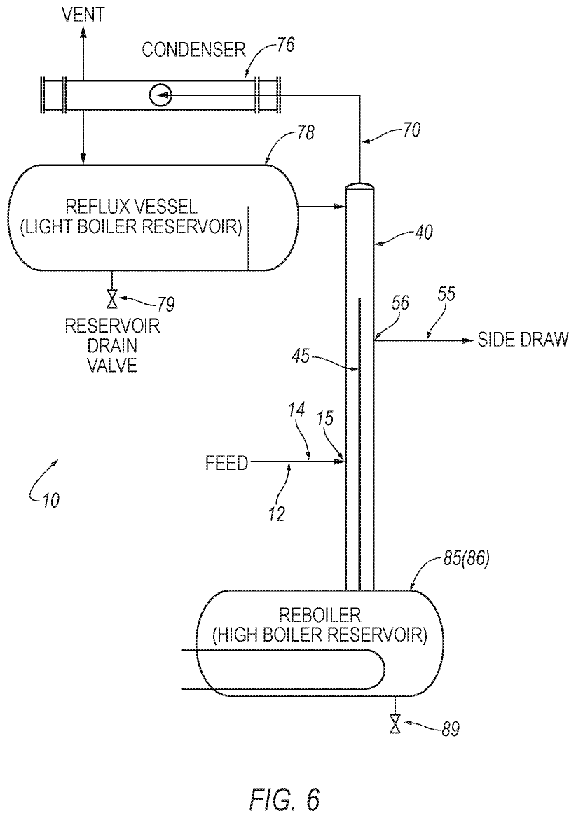

The specific number of sequestering reservoirs, their functionality, the presence or absence of separate collection vessels such as for example shown at 78 in FIG. 1 and the presence or absence of reflux may depend on a variety of factors, including without limitation column partition wall location, amount and type of heat transfer fluid contaminants, flow rates, and other specific factors based on the design configuration. A number of non-limiting exemplary embodiments and configurations are depicted in FIGS. 2 through 6. FIG. 2 depicts an embodiment of the synthetic aromatic heat transfer fluid regenerating assembly of the present invention that includes a divided wall distillation column 40 that includes a partition wall 45 centrally disposed in column interior 42; a low boiler sequestering reservoir 75 with reflux pipeline 97 and including a condenser 76 and reflux drum 78; and a high boiler sequestering reservoir 85 with boilup or partial boilup pipeline 98 and including a reboiler 86. FIGS. 3 and 4 depict embodiments of the synthetic aromatic heat transfer fluid regenerating assembly of the present invention that includes a divided wall distillation column 40 that includes a partition wall 45 extending upward from the column base 41 into column interior 42; a low boiler sequestering reservoir 75 with reflux 97 and including condenser 76 and reflux drum 78; and a high boiler sequestering reservoir 85 with boilup or partial boilup pipeline 98 and including two sequestering reboilers 86 and 86′ and boilup pipelines 98 and 98′ FIG. 4 depicts an embodiment that further includes a transfer stream 91 for transporting liquid from one side of the divided wall column to the other. Optionally, the transport of liquid may be accomplished with aid of a device such as a pump. FIG. 5 depicts an embodiment of the synthetic aromatic heat transfer fluid regenerating assembly 10 of the present invention that includes a divided wall distillation column 40 that includes a partition wall 45 extending downward from the column top 43 into column interior 42; a low boiler sequestering reservoir 75 with reflux pipeline 97 and including sequestering condensers 76 and 76′ that include separate reflux drums (collection vessels) 78 and 78′; and a high boiler sequestering reservoir 85 with boilup (or partial boilup) pipeline 98 and a sequestering reboiler 86. FIG. 6 depicts and embodiment of the synthetic aromatic heat transfer fluid regenerating assembly 10 of the present invention that includes a divided wall distillation column 40 that includes a partition wall 45 extending upward from the column base 41 into column interior 42; a low boiler sequestering reservoir 75 with reflux pipeline 97 and including sequestering condenser 76 that includes a separate collection vessel 78; and a high boiler sequestering reservoir 85.

In one or more embodiments, the synthetic aromatic heat transfer fluid regenerating assembly 10 of the present invention may optionally include other auxiliary equipment, systems or apparatuses, such as systems useful for operation with any specific synthetic aromatic heat transfer fluid under vacuum conditions. For example, for operation at reduced pressure and temperature conditions (e.g. subatmospheric conditions), a vacuum pump or system including a plurality of vacuum pumps and/or systems may be included with said regenerating assembly. With reference to the Figures., said vacuum pump or system may be connected to said regeneration assembly by a connection to the condenser. Although it should be evident to one skilled in the art that a vacuum pump or system may be connected at any location within the said regeneration assembly where it can effectively facilitate reduced pressure and/or temperature within said assembly.

In another non-limiting optional equipment example, an odor mitigation device or pollution mitigation may also be connected to said regeneration assembly as required or desired. Examples of these types of devices are, but not limited to, flare systems, combustion systems, volatile organic compound (VOC) destruction systems, regenerative oxidation devices, thermal oxidation devices, and/or catalytic oxidation systems. Additional optional or auxiliary equipment may be readily apparent to one of ordinary skill in the art.

One of ordinary skill will be appreciate that the regeneration assembly may be constructed from compatible materials of construction consistent with operation associated with degradation products. For example, if a degradation product from a given synthetic aromatic heat transfer fluid is known to be corrosive, it may be advantageous to construction the assembly from corrosion resistant materials such as high nickel content steel.

Another advantageous feature of one or more embodiments of the present invention is the transportable construction of the synthetic aromatic heat transfer fluid regenerating assembly. In such embodiments, the synthetic aromatic heat transfer fluid regenerating assembly may be a modular unit or a single unit or a single self-contained unit or a single enclosed unit as shown in FIG. 1. In one or more embodiments, the synthetic aromatic heat transfer fluid regenerating assembly 10 may be purposefully transportable and may include elements such a support base 62 supporting a divided wall distillation column 40; one or more transportation elements 61 such as wheels, rollers, sliders or the like to facilitate movement or transportation between first and second locations, e.g., from an inactive, remote or storage location to an active functional location near or adjacent to a heat transfer system and with optional return to the inactive, remote or storage location and an optional enclosure 60. Additionally, said assembly may be constructed so as to be transportable within a shipping container or a standard intermodal transport container as consistent with ISO standard 668:2020 or analogous container used for bulk cargo. In such embodiments, the synthetic aromatic heat transfer fluid regenerating assembly may also include a releasable fluid connector for fluidly connecting said synthetic aromatic heat transfer fluid regenerating assembly to a heat transfer system as described elsewhere herein (for example, quick connect hoses).

In a third and related aspect, the present invention relates to a heat transfer assembly 60, depicted generally in FIG. 1. The heat transfer assembly of the present invention includes (a) a heat transfer system 5 comprising contaminated synthetic aromatic heat transfer fluid contained in a heat transfer loop 6 and (b) a synthetic aromatic heat transfer fluid regenerating assembly 10, more particularly the synthetic aromatic heat transfer fluid regenerating assembly 10 of the present invention, fluidly connected to said heat transfer system 5. The synthetic aromatic heat transfer fluid regenerating assembly 10 comprises a divided wall distillation column 40 including a side-draw outlet 56 for side draw stream 55. In one or more embodiments, the synthetic aromatic heat transfer fluid regenerating assembly 10 is releasably connected to the heat transfer system 5 and includes at least one releasable fluid connector 15 fluidly connecting the synthetic aromatic heat transfer fluid regenerating assembly to the heat transfer system.

In embodiments, the heat transfer assembly of the present invention may be operated in various modes to provide a supply of regenerated synthetic aromatic heat transfer fluid. In a first and preferred mode, the heat transfer system is an operating heat transfer system that may be described as active, functional or operational, and includes synthetic aromatic heat transfer fluid circulating in the heat transfer loop and providing heat transfer functionality to the related chemical process, device or system (for example, a concentrated solar power facility). In this mode, a portion of the contaminated synthetic aromatic heat transfer fluid is diverted or withdrawn from the heat transfer system to the synthetic aromatic heat transfer fluid regenerating assembly. Accordingly, in one or more embodiments, the heat transfer assembly includes a first portion of contaminated synthetic aromatic heat transfer fluid circulating in the heat transfer loop and a second portion of contaminated synthetic aromatic heat transfer fluid flowing into/through the synthetic aromatic heat transfer fluid regenerating assembly. In another mode of operation, the heat transfer system may be described as inactive, non-functional or non-operational, as if shut down. In this mode, synthetic aromatic heat transfer fluid may reside or be contained in the heat transfer loop but is not circulating in the loop and is not and is not providing heat transfer functionality to the related chemical process, device or system.

In one or more embodiments, the material from the side-draw outlet of the divided wall distillation column 40 (i.e., regenerated synthetic aromatic heat transfer fluid) is collected. In one or more embodiments, the material from the side-draw outlet of the divided wall distillation column (i.e., regenerated synthetic aromatic heat transfer fluid) is returned to the heat transfer system as shown in FIG. 1. Accordingly, in some embodiments, the heat transfer system includes a regenerated synthetic aromatic return line 65 releasably connected to the heat transfer loop 6.

As noted elsewhere herein, one of ordinary skill will understand and appreciate that elements or features described in one aspect or embodiment of the present invention may be applicable and useful in describing other aspects or embodiments. By way of non-limiting examples, the description of the divided wall distillation column set forth in the context of the method of the present invention is also applicable and useful in describing the divided wall distillation column feature of the heat transfer system of the present invention and/or the synthetic aromatic heat transfer fluid regenerating assembly of the present invention. Further, descriptions related to the divided wall distillation column set forth in the context of the heat transfer system of the present invention and the synthetic aromatic heat transfer fluid regenerating assembly of the present invention are also applicable and useful in describing the divided wall distillation column in the context of the method of the present invention. Similarly, description relating to the at least one low boiler sequestering reservoir set forth in the heat transfer system aspect of the present invention and/or the synthetic aromatic heat transfer fluid regenerating assembly aspect of the present invention may be applicable and useful in describing the low boiler sequestering reservoir feature of the methods of the present invention. Accordingly, descriptions and disclosure relating to elements or features of an aspect or embodiment of the present invention are hereby expressly relied on to describe and support those elements or features in other aspects or embodiments.

Accordingly, in one or more embodiments, heat transfer assembly 60 includes a heat transfer fluid regenerating assembly 10 comprising a feed pipeline 14 carrying feed stream 12 with releasable fluid connector 15 releasably connecting said heat transfer fluid regenerating assembly 10 to said heat transfer system 5, preferably at heat transfer loop 6. In one or more embodiments, the heat transfer assembly 10 includes at least one low boiler sequestering reservoir 75 fluidly connected to the divided wall distillation column 40 and at least one high boiler sequestering reservoir 85 fluidly connected to the divided wall distillation column 40, with the at least one low boiler sequestering reservoir 75 including a sequestering condenser 76 in some embodiments and the at least one heavy boiler sequestering reservoir 85 including a sequestering reboiler 86 in some embodiments.

Further, in one or more embodiments, the heat transfer assembly of present invention may include a synthetic aromatic heat transfer fluid regenerating assembly 10 that may be a modular unit or a single unit or a single self-contained unit or a single enclosed unit that in some embodiments, may be purposefully transportable or mobile and may include elements such a support base 62 supporting the divided wall distillation column 40, an optional enclosure 60 and one or more transportation elements such as wheels, rollers, sliders or the like to facilitate movement or transportation between first and second locations.

The following examples, while provided to illustrate with specificity and detail the many aspects and advantages of the present invention, are not to be interpreted as in any way limiting its scope. Variations, modifications and adaptations which do depart of the spirit of the present invention will be readily appreciated by one of ordinary skill in the art.

### Invention Example

To illustrate the many benefits of the present invention, a simulation of an embodiment of the regeneration assembly of the present invention as depicted in FIG. 6 was performed using ASPEN® Plus™ process simulation software. In this non-limiting exemplary embodiment, the synthetic aromatic heat transfer fluid regenerating assembly 10 included a divided wall distillation column 40 including a dividing wall 45 extending from the bottom or base of the column toward and into the interior; a low boiler sequestering reservoir 75 with reflux 97 and that includes a sequestering condenser 76 and a separate collection vessel 78 and a high boiler sequestering reservoir 85. In this example, a feed flow rate of contaminated synthetic aromatic heat transfer fluid, more specifically a eutectic biophenyl oxide/diphenyl oxide mixture commercially available as Dowtherm™ A, was set at 375 kg/hr on a continuous basis, with average contaminated synthetic aromatic heat transfer fluid feed composition assumed to be approximately 97 wt. % synthetic aromatic heat transfer fluid with approximately 0.9 wt. % low/light boiler degradation contaminants (e.g., benzene and phenol) and approximately 2.1 wt. % high/heavy boiler degradation contaminants (e.g., isomers of terphenyl). The returned “regenerated” synthetic aromatic heat transfer fluid material has an average composition of 98.2 wt. % synthetic aromatic heat transfer fluid with approximately 1.6 wt. % high/heavy boiler degradation contaminants and approximately 0.2 wt. % low/light boiler degradation contaminants.

The configuration of the divided wall column used in the simulation is as follows:
Feed side of the column (left hand side in FIG. 6) has 6 theoretical stages with the feed entering above the 6^{th} stage from the top
Outlet side of the column (right hand side in FIG. 6) has 5 theoretical stages with the liquid sidedraw withdrawn from the 2^{nd} stage from the top.
The top of column above the wall comprises 2 theoretical stages plus a condenser (one theoretical stage)
The bottom of column comprises a kettle reboiler (one theoretical stage)
The vapor from the reboiler is equally divided between the feed and outlet sides of the column.
The liquid downflow from the top of the column divided 40/60 between the feed and outlet sides of the column, respectively.
The column is assumed to packed with Mellapak™ PL 202Y structured packing

Each theoretical stage except the condenser and reboiler is assumed to be 39 inches (1 meter) in packed height.

For a heat transfer system with a total inventory of 1300 metric tons (1,300,000 kg) of synthetic aromatic heat transfer fluid, it would take approximately 3467 hours (20.6 weeks) of continual operation to process the inventory. Assuming, periodic removal of the sequestered light and high boilers from respective sequestering reservoirs, two liquid reservoirs with about 1700 gallons (6.4 m³) capacity would be sufficient to allow buildup of degradation contaminants for about 1700 hours (10.3 weeks) before the reservoirs are drained.

Based on distillation column sizing correlations within the ASPEN Plus software, the calculated cross-sectional area for the “left” and “right” hand sides of the divided wall column were approximately 46.3 in² and 42.7 in², respectively, resulting in a full column diameter of approximately 10.7 inches. The sizing assumption for column packing and column diameter was for assembly operation at a maximum of 80% of flooding.

Based on the simulation results, in terms of overall size, a synthetic aromatic heat transfer fluid regeneration assembly may include the following:
A kettle reboiler—66 inch OD (167 cm)×10 feet (3.05 m) t-t length (1700 gallons liquid inventory) w/heating coils
A reflux vessel—66 inch OD (167 cm)×10 feet (3.05 m) t-t length (1700 gallons liquid inventory)
A condenser

A divided wall column shell—11 inch (28 cm) OD×20 ft (6.1 m) t-t height Heat and material balance results from the ASPEN Plus simulation are set forth in Table 1 below.

TABLE 1

| | | | Liquid | Liquid | |
|---|---|---|---|---|---|
| | | Vapor | Distillate | Underflow | |
| | Feed | Distillate | (sequestered) | (sequestered) | Sidedraw |
| | (kg/hr) | (kg/hr) | (kg/hr) | (kg/hr) | (kg/hr) |
| Dowtherm A | 363.75 | | 0.99 | 2.02 | 360.78 |
| Benzene | 0.75 | 0.01 | 0.74 | | |
| Phenol | 2.63 | | 2.01 | | 0.61 |
| o-Terphenyl | 5.63 | | | 0.36 | 5.28 |
| m-Terphenyl | 1.13 | | | 0.60 | 0.54 |
| p-Terphenyl | 1.13 | | | 0.84 | 0.29 |
| Total: | 375.0 | 0.0 | 3.7 | 3.8 | 367.5 |
| Temperature (deg C.) | 200 | 114.2 | 114.2 | 279.8 | 257.8 |
| Pressure (bara) | 1.5 | 1.013 | 1.013 | 1.046 | 1.030 |
| | (wt %) | (wt %) | (wt %) | (wt %) | (wt %) |
| Dowtherm A | 97 | 0.30 | 26.52 | 52.98 | 98.17 |
| Benzene | 0.2 | 92.22 | 19.70 | | |
| Phenol | 0.7 | 7.48 | 53.78 | 0.01 | 0.17 |
| o-Terphenyl | 1.5 | | | 9.37 | 1.44 |
| m-Terphenyl | 0.3 | | | 15.64 | 0.15 |
| p-Terphenyl | 0.3 | | | 22.00 | 0.08 |

Heat Duties

| Reboiler | Condenser |
|---|---|
| (BTU/hr) | (BTU/hr) |
| 270,746 | 226,648 |

### Comparative Example

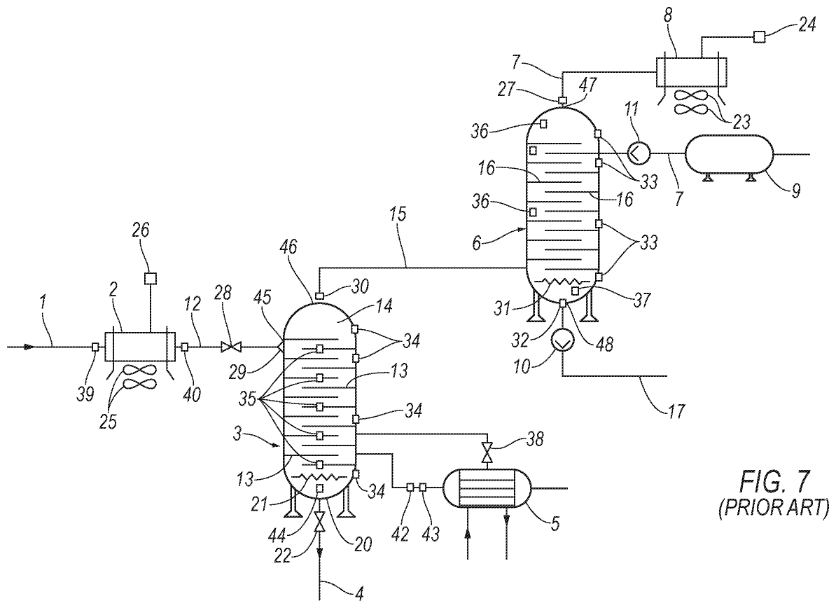

To compare and contrast the present invention, an ASPEN Plus chemical process simulation was also developed for a similar heat transfer reclamation system based on the description and example provided in U.S. Pat. No. 9,211,484 and depicted in FIG. 1 of that patent, which is reproduced as FIG. 7 in the present application. In this comparative example, the total inventory of the heat transfer system was 1300 metric tons. Using the specification, description and Figures set forth in the '484 patent and applying a 6,500 kg/hr feed rate, the results set forth in Table 2 below were obtained from the ASPEN simulation.

TABLE 2

| | | Vapor | | Liquid | Liquid |
|---|---|---|---|---|---|
| | Feed | Distillate | Sidedraw | Underflow | Distillate |
| Compounds | (kg/hr) | (kg/hr) | (kg/hr) | (kg/hr) | (kg/hr) |
| Dowtherm A | 6500.0 | 0.5 | 6129.5 | 253.5 | 116.5 |
| Benzene | 6129.5 | 0.0 | 6093.8 | 17.3 | 18.4 |
| Phenol | 26.0 | 0.4 | 0.9 | 0.0 | 24.6 |
| o-Terphenyl | 91.0 | 0.0 | 17.5 | 0.0 | 73.5 |
| m-Terphenyl | 188.5 | 0.0 | 15.6 | 172.9 | 0.0 |
| p-Terphenyl | 32.5 | 0.0 | 0.9 | 31.6 | 0.0 |
| Total: | 0.0 | 0.0 | 0.0 | 0.0 | 0.0 |
| Temperature (deg C.) | 100 | 127.9 | 274.4 | 349.4 | 127.9 |
| Pressure (bara) | 32 | 1.5 | 1.5 | 1.5 | 1.5 |
| | (wt %) | (wt %) | (wt %) | (wt %) | (wt %) |
| Dowtherm A | 94.3 | 0.21 | 99.42 | 6.82 | 15.78 |
| Benzene | 0.4 | 90.26 | 150 ppm | | 21.15 |
| Phenol | 1.4 | 9.53 | 0.28 | | 63.07 |
| o-Terphenyl | 2.9 | | 0.25 | 68.20 | |
| m-Terphenyl | 0.5 | | 155 ppm | 12.45 | |
| p-Terphenyl | 0.5 | | 118 ppm | 12.54 | |

Heat Duties

| Feed | | |
|---|---|---|
| Cooler | Reboiler | Condenser |
| (BTU/hr) | (BTU/hr) | (BTU/hr) |
| 2,632,398 | 3,974,978 | 1,756,491 |

Noting that the reclamation system described in the '484 patent is intended to be operated continuously, not batchwise. In other words, the reclamation system described in the '484 patent withdraws contaminated Dowtherm A material from a heat transfer system and processes the contaminated material through their apparatus periodically. Presumably, this withdrawing would require a shutdown or interruption in normal operation of the heat transfer system. As such, it would require 200 operational hours to process 1300 metric tons of material, commiserate with a shutdown time of roughly 8 to 9 days.

Numerous advantages and benefits of the present invention may be easily and clearly observed by comparing the present invention to the prior art, including reference to the above examples. One advantage is that the physical size of the regeneration assembly of the present invention is significantly smaller compared to the known art. The assembly may in some embodiments be in the form of a single enclosed unit with significant lower average flowrate versus a dual distillation column system with 20 times greater average flowrate. As a result, the capital cost of the divided wall system would be expected to be corresponding lower.

Another advantage is that impurities are continually being sequestered and accumulated in reservoirs within the divided wall system in such a manner that low and high boiling impurities are constantly being physically separated (by sequestering in the low boiler and high boiler reservoirs) from the heat transfer fluid. Instead of allowing impurities to accumulate then removing said impurities within a relatively short period of time (i.e., 200 hours), the regeneration assembly of the present invention may operate continuously for long periods to sequester (localized accumulation and concentration) impurities in situ and concurrent with operation of the associated heat transfer system. Therefore, even though the average throughput for the divided wall system is lower, the concurrent and continual impurity removal allows for a smaller overall apparatus. Conversely, the conventional system allows accumulation of impurities in the heat transfer fluid with reduction in impurity concentration only on a periodic basis.

Still another advantage is the ability of the divided wall system to operate while not interrupting the primary function of the heat transfer system. In this instance, a small slipstream feed (e.g., as low as 1/4000th) of the total heat transfer fluid inventory may be processed per hour. This represents a sufficiently minor fraction of the total heat transfer system size that it allows operation of the reclamation concurrent with heat transfer system operation and in situ, without imparting a significant heat duty load on the overall system.

In some embodiments, a further advantage is that the assembly may exclude fluid transport pressure elements such as pumps and similar mechanical device elements, relying instead on natural gravitational forces or nominal heat transfer system pressure, with heat input as required, to transport fluid through the assembly. Specifically, in embodiments where the only liquid outlet stream from the synthetic aromatic heat transfer fluid regeneration assembly is a side-draw, it may be possible to simply drain the unit using a vacuum or seal leg based on setting the elevation of the side-draw sufficiently above a return tank operated at atmospheric pressure. Accordingly, in some embodiments, the passing step (b) of the method of the present invention may comprise the step of applying gravity forces to the synthetic aromatic heat transfer fluid, preferably in the absence of positive pressure purposefully applied by a component of the regeneration assembly. Similarly, the synthetic aromatic heat transfer fluid regeneration assembly of the present invention may include an assembly of components that excludes or does not include purposeful pressure-applying elements or devices such as pumps.

Still yet another advantage of the present invention the flexibility with regard to heat source to operate elements of the synthetic aromatic heat transfer fluid regeneration assembly which may require thermal energy, such as for example a sequestering reboiler. In one example, if the divided wall column of the synthetic aromatic heat transfer fluid regeneration assembly is operated at a substantially lower temperature and pressure than the heat transfer system, the heat source for the sequestering reboiler may receive thermal energy from the contaminated synthetic aromatic heat transfer fluid, the regenerated synthetic aromatic heat transfer fluid and/or a combination thereof. Accordingly, in one or more embodiments, the step of collecting a low boiler distillate stream in a low boiler sequestering reservoir in the method of the present invention may include collecting a low boiler distillate stream in a sequestering reboiler receiving at least a portion of or the majority of or its entire requirements for thermal energy from the contaminated synthetic aromatic heat transfer fluid, the regenerated synthetic aromatic heat transfer fluid and/or a combination thereof. Similarly, the synthetic aromatic heat transfer fluid regeneration assembly of the present invention may include a sequestering reboiler receiving at least a portion of or the majority of or its entire requirements for thermal energy from the contaminated synthetic aromatic heat transfer fluid, the regenerated synthetic aromatic heat transfer fluid and/or a combination thereof. Additionally, an external heat supply may be used, for example, electric heaters may also be used for the heat source for the reboiler.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method for regenerating contaminated synthetic aromatic heat transfer fluid from a heat transfer system comprising contaminated synthetic aromatic heat transfer fluid contained in a heat transfer loop, said method comprising the steps of (a) diverting at least a portion of said contaminated synthetic aromatic heat transfer fluid from said heat transfer system to form a feed stream comprising contaminated synthetic aromatic heat transfer fluid; and (b) passing said feed stream comprising diverted contaminated synthetic aromatic heat transfer fluid into a synthetic aromatic heat transfer fluid regenerating assembly, said synthetic aromatic heat transfer fluid regenerating assembly comprising a divided wall distillation column, to form a side draw stream, a low boiler distillate stream and high boiler distillate stream.

2. The method of claim 1 wherein said heat transfer system is an operating heat transfer system comprising circulating contaminated synthetic aromatic heat transfer fluid that is circulating in said heat transfer loop and said collecting step (a) comprises diverting at least a portion of said circulating contaminated synthetic aromatic heat transfer fluid from said heat transfer system to form a diverted contaminated synthetic aromatic heat transfer fluid stream.

3. The method of claim 1 wherein said synthetic aromatic heat transfer fluid regenerating assembly is a releasably connectable synthetic aromatic heat transfer fluid regenerating assembly and said method further comprises, prior to step (b), a step of connecting said releasably connectable synthetic aromatic heat transfer fluid regenerating assembly to said heat transfer system.

4. The method of claim 3 further comprising a step of disconnecting said releasably connectable synthetic aromatic heat transfer fluid regenerating assembly from said heat transfer system.

5. The method of claim 1 further comprising accumulating at least one of said low boiler distillate stream and said high boiler distillate stream in at least one sequestering reservoir.

6. The method of claim 5 comprising accumulating said low boiler distillate stream in a low boiler sequestering reservoir and accumulating said high boiler distillate stream in a high boiler sequestering reservoir.

7. The method of claim 1 further comprising returning at least a portion of material from said side draw stream to said heat transfer system.

8. A synthetic aromatic heat transfer fluid regenerating assembly, said assembly comprising (a) a fluid connector for fluidly connecting said synthetic aromatic heat transfer fluid regenerating assembly to a heat transfer system, said system comprising contaminated synthetic aromatic heat transfer fluid contained in a heat transfer loop; and (b) a divided wall distillation column fluidly connected to said fluid connector and comprising a side-draw outlet.

9. The synthetic aromatic heat transfer fluid regenerating assembly of claim 8 further comprising (c) at least one light boiler sequestering reservoir fluidly connected to said divided wall distillation column; and (d) at least one heavy boiler sequestering reservoir fluidly connected to said divided wall distillation column.

10. The synthetic aromatic heat transfer fluid regenerating assembly of claim 9 wherein said fluid connector (a) is a releasable fluid connector.

11. The synthetic aromatic heat transfer fluid regenerating assembly of claim 9 wherein said at least one light boiler sequestering reservoir comprises a sequestering condenser or said at least one heavy boiler sequestering reservoir comprises a sequestering reboiler.

12. The synthetic aromatic heat transfer fluid regenerating assembly of claim 9 wherein said divided wall distillation column, said at least one light boiler sequestering reservoir and said at least one heavy boiler sequestering reservoir together form a single modular unit.

13. A heat transfer assembly, said assembly comprising (a) a heat transfer system comprising contaminated synthetic aromatic heat transfer fluid contained in a heat transfer loop; and (b) a synthetic aromatic heat transfer fluid regenerating assembly fluidly connected to said heat transfer system; wherein said heat transfer fluid regenerating assembly comprises a divided wall distillation column.

14. The heat transfer assembly of claim 13 wherein the heat transfer assembly is an operating heat transfer assembly comprising includes a first portion of contaminated synthetic aromatic heat transfer fluid circulating in said heat transfer loop and a second portion of contaminated synthetic aromatic heat transfer fluid flowing into said synthetic aromatic heat transfer fluid regenerating assembly.

15. The heat transfer assembly of claim 13 wherein said heat transfer fluid regenerating assembly further comprises a releasable fluid connector releasably connecting said heat transfer fluid regenerating assembly to said heat transfer loop.

16. The heat transfer assembly of claim 13 further comprising at least one low boiler sequestering reservoir fluidly connected to said divided wall distillation column and at least one high boiler sequestering reservoir fluidly connected to said divided wall distillation column.

17. The heat transfer assembly of claim 16 wherein said at least one low boiler sequestering reservoir includes a sequestering condenser or said at least one heavy boiler sequestering reservoir includes a sequestering reboiler.

18. The heat transfer assembly of claim 16 wherein said divided wall distillation column, said at least one low boiler sequestering reservoir and said at least one high boiler sequestering reservoir together form a single modular unit.

19. The heat transfer assembly of claim 13 further comprising a regenerated synthetic aromatic return line releasably connected to said heat transfer loop.
